(19) United States
(12) Patent Application Publication
(10) Pub. No.: US 2010/0274947 A1
(43) Pub. Date: Oct. 28, 2010

(54) MEMORY MANAGEMENT METHOD, MEMORY MANAGEMENT PROGRAM, AND MEMORY MANAGEMENT DEVICE

(75) Inventors: Tomoya Ohta, Sagamihara (JP); Ryozo Yamashita, Yokohama (JP); Hiroyasu Nishiyama, Kawasaki (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/703,691

(22) Filed: Feb. 10, 2010

(30) Foreign Application Priority Data
Apr. 27, 2009 (JP) 2009-107783

(51) Int. Cl. G06F 12/00; G06F 9/455; G06F 12/10; G06F 12/02

(52) U.S. Cl. 711/6; 718/1; 711/170; 711/206; 711/E12.001; 711/E12.009

(57) ABSTRACT

In a virtual machine system built from a plurality of virtual machines, the utilization efficiency of utilized physical memory is raised. A memory management method in which a virtual machine environment, constituted by having one or several virtual machines and a hypervisor part for operating the same virtual machines, is built on a physical machine and in which: a virtual machine operates an allocation processing part and an application part, application part making a physical memory processing part allocate unallocated physical memory to a memory area and allocation processing part transmitting, when unallocated physical memory is scarce, an instruction for the release, from memory areas utilized by each application part, of memory pages for which physical memory is assigned but not used.

### BACKGROUND OF THE INVENTION

1. Field of the Invention

The present invention pertains to a memory management method, a memory management program, and memory management device technology.

2. Description of the Related Art

In Carl A. Waldspurger, “Memory Resource Management in VMware ESX Server”, OSDI 2002, there is disclosed virtual machine environment technology partitioning one physical machine virtually and building a plurality of virtual machines.

In a virtual machine system constituted by a virtual machine environment such as this, there are times when the allocation of physical memory of the physical machine ends up becoming unbalanced, since physical memory is allocated to the respective virtual machines and managed by partitioning.

E.g., there arises a situation in which, whereas idle memory is distributed on each virtual machine and there exist virtual machines that have excess memory, memory is insufficient and swap-outs to an auxiliary storage device such as a memory page hard disk due to the memory management of the operating system (OS) occur frequently.

Moreover, there is also the possibility that there occur situations in which memory that can be used for the launch of a new virtual machine and that is allocated to the virtual machines is insufficient.

In Waldspurger, op.cit., ballooning technology is disclosed as one means of solving problems such as these. In ballooning technology, a device driver is assigned to the OS operating on the virtual machine; the device driver, based on an instruction from the virtual machine environment, requests a memory allocation with respect to the OS; and the memory area allocated to the device driver is returned to the virtual machine environment. As for the area returned in this way, it becomes possible to allocate the same to another virtual machine.

Technologies making practical use of memory efficiently are a requirement that is not limited to virtualization environments and so far, a great number thereof have been disclosed.

In JP-A-2005-208785, there is disclosed technology in which memory is efficiently put to practical use among a plurality of tasks running on an OS. The present technology maps memory areas used by two tasks to one and the same memory area, allocates memory from the most significant bit of the address in a certain task and, in a separate task, from the least significant bit of the address and, if idle memory is insufficient, a memory release request is sent to the first task. This technology is effective in case there is a relationship such that the memory use level of the other task diminishes in case the memory use level of one task has increased.

In JP-A-2005-322007, there is disclosed a memory management method in which, in case memory is insufficient in a certain processing program A, a release of idle memory is requested with respect to some separate processing program B, the same idle memory is returned to the system and, for a second time, a memory allocation request is carried out with respect to processing program A.

### SUMMARY OF THE INVENTION

As mentioned above, if the respective physical memory allocations of a plurality of virtual machines end up becoming unbalanced, the utilization efficiency of physical memory ends up deteriorating, and the processing efficiency of the entire virtual machine system ends up worsening.

As for the technology in Waldspurger, op.cit., if memory has become insufficient, memory is released from each of the virtual machines. As a result, it is necessary to wait for the occurrence of memory shortage, so, accompanying the program memory shortage, there ends up occurring a decline in the processing efficiency. Also, as for the technology in Waldspurger, the applications operating on the OS of a virtual machine are ensured, but it is not possible to release unused memory.

As for the technology of JP-A-2005-208785, in case there is not the relationship that, in case the memory use level of one task has increased, the memory use level of another task diminishes, there is the possibility that the memory that is required simultaneously increases, in which case memory shortages are provoked more easily. Also, a plurality of tasks cannot be accommodated.

In the technology of JP-A-2005-322007, release of memory of a separate program is carried out only in the case where a memory shortage occurs. As a result, there is the possibility that a memory release is carried out in the case where the load of the separate program is high and the performance of the separate program is reduced.

Accordingly, the present invention has for its main object to solve the aforementioned problems by raising the utilization efficiency of the utilized physical memory in a virtual machine system built of a plurality of virtual machines.

In order to solve the aforementioned problems, the present invention is a memory management method which, together with building, on a physical machine, the aforementioned virtual machine environment constituted by having one or several virtual machines and a hypervisor part for operating the same virtual machine(s), allocates physical memory inside a main storage device of said physical machine to a memory area used by an application part operating on said virtual machine; and in which:

the aforementioned virtual machine operates an allocation processing part and the aforementioned application part;

the aforementioned application part, by prohibiting physical memory allocation processing and release processing from the aforementioned virtual machine regarding the used aforementioned memory area and transmitting a request to the effect of allocating physical memory to a physical memory processing part inside the aforementioned hypervisor part, makes the aforementioned physical memory processing part allocate unallocated physical memory with respect to the aforementioned memory area; and

the aforementioned allocation processing part, when said unallocated physical memory is scarce, transmits, to each of the aforementioned application parts operating respectively on the aforementioned one or several virtual machines, an instruction for the release, from the aforementioned memory areas, utilized by each of the aforementioned application parts, of memory pages which are unused but for which physical memory is allocated.

Other means will be mentioned subsequently.

According to the present invention, it is possible to increase the utilization efficiency of the utilized physical memory in a virtual machine system built of a plurality of virtual machines.

### BRIEF DESCRIPTION OF THE DRAWINGS

FIG. 1 is a block diagram showing a physical machine on which a virtual machine environment pertaining to an embodiment of the present invention is built.

FIG. 2 is a block diagram showing a physical machine on which there is built a virtual machine environment, different from that of FIG. 1 and pertaining to an embodiment of the present invention.

FIG. 3 is a block diagram showing the details of each of the processing parts (allocation processing part, application part, and physical memory processing part) shown in FIG. 1 and FIG. 2 and pertaining to an embodiment of the present invention.

FIGS. 4A and 4B are explanatory diagrams showing physical memory states inside memory areas pertaining to an embodiment of the present invention.

FIG. 5 is a set of tables pertaining to an embodiment of the present invention, comprising a processing state management table and two states of a memory allocation management table.

FIG. 6 is a flowchart showing the operation of the physical machine of FIG. 1, pertaining to an embodiment of the present invention.

FIG. 7 is a flowchart showing memory area initialization processing executed by a start and initialization part pertaining to an embodiment of the present invention.

FIG. 8 is flowcharts showing the details of memory area access processing of an application part pertaining to an embodiment of the present invention.

FIG. 9 is a flowchart showing the details of active memory release request processing executed by an allocation control part pertaining to an embodiment of the present invention.

### DESCRIPTION OF THE EMBODIMENT

Hereinafter, an embodiment of the present invention will be described in detail with reference to the drawings.

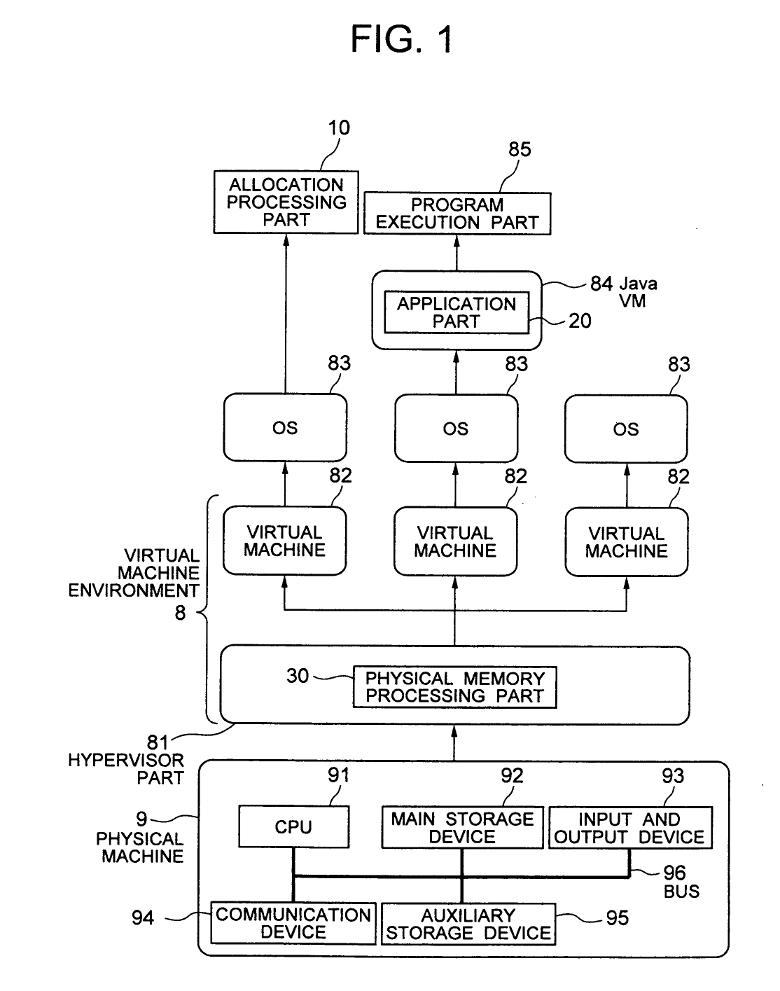

FIG. 1 is a block diagram showing a physical machine 9 on which a virtual machine environment 8 is built. In FIG. 1, there is shown a layer model of virtual machine environment 8 by indicating arrows pointing from a lower level to a higher level. E.g., an arrow from physical machine 9 to a hypervisor part 81 is included, and this arrow indicates the principle of the lower level (physical machine 9) being utilized to build a higher level (hypervisor part 81), the hypervisor part 81 actually being present in the interior (main storage device 92) of physical machine 9.

Hereinafter, an explanation will be given of a layer model showing virtual machine environment 8 on physical machine 9. The explanation will be given in the order from the lowest level (1) to the highest level (5). In this layer model, the (n+1)th layer utilizes the nth layer and is built thereon.

The physical layer (the level of physical machine 9), Layer 1, is the lowest layer. Physical machine 9 of this layer is a computer constituted by a CPU (Central Processing Unit) 91, a main storage device 92, an input and output device 93, a communication device 94, and an auxiliary storage device 95, which are connected with a bus 96.

Virtual machine environment 8 of Layer 2 is built by means of having CPU 91 of physical machine 9 load a program, for configuring virtual machine environment 8 from auxiliary storage device 95, to main storage device 92 and execute the same. Virtual machine environment 8 is constituted by a hypervisor part 81, controlling one or several virtual machines 82, and virtual machines 82, each being built independently as a computer that is virtual, which receive the allocation of physical machine 9 resources (main storage device 92 physical memory and the like) from the same hypervisor part 81. A physical memory processing part 30 inside hypervisor part 81 accesses the resources of physical machine 9 and executes allocation and release of the same.

OS 83 of Layer 3 are built on virtual machines 82. In other words, it is possible to independently start an OS 83, of the same type or different types, for each of the virtual machines 82. An allocation processing part 10 activated on an OS 83 controls the resource allocation of a Java™ VM (Virtual Machine) 84 (application part 20) built on a virtual machine 82 that is different from the virtual machine 82 with which the allocation processing part is affiliated (which may be a virtual machine 82 inside the same physical machine 9 or a virtual machine 82 inside a separate physical machine 9 or it may not be a virtual machine).

JAVA VM 84 of Layer 4 is a Java program execution environment built on an OS 83. Further, instead of a Java VM 84, it is acceptable to adopt another execution environment having a memory management mechanism. Application part 20 controls the allocation and release of resources used by the Java VM 84 with which it is affiliated. Further, the number of virtual machines 82 operated by an application part 20 is not limited to one, as shown in FIG. 1, it being acceptable for several to be present inside physical machine 9.

A program execution part 85 of Layer 5 executes Java programs using the Java VM 84 execution environment (class libraries and the like).

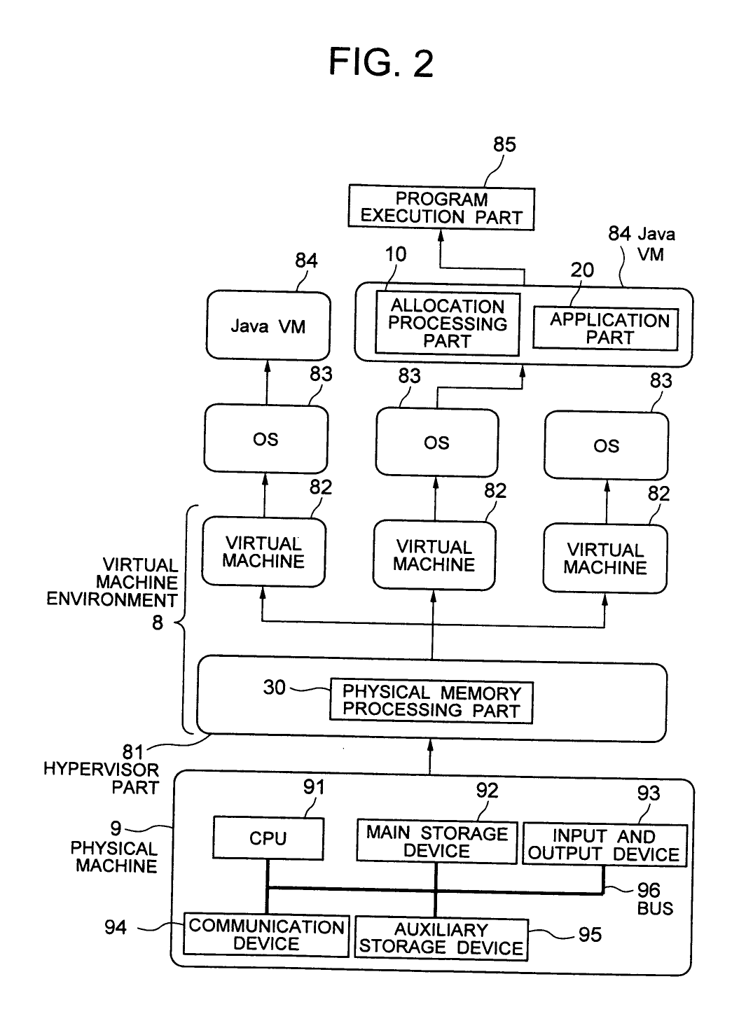

FIG. 2 is a block diagram showing a physical machine 9 on which there is built a virtual machine environment 8, different from that of FIG. 1. In FIG. 1, allocation processing part 10 and application part 20 were present on separate virtual machines 82, but in FIG. 2, allocation processing part 10 and application part 20 are present on the same virtual machine 82. In other words, allocation processing part 10 controls the resource allocation of the Java VM 84 (application part 20) which is built on the virtual machine 82 with which it is itself affiliated. Allocation processing part 10 of this FIG. 2 operates as one thread within Java VM 84 and is executed at prescribed intervals.

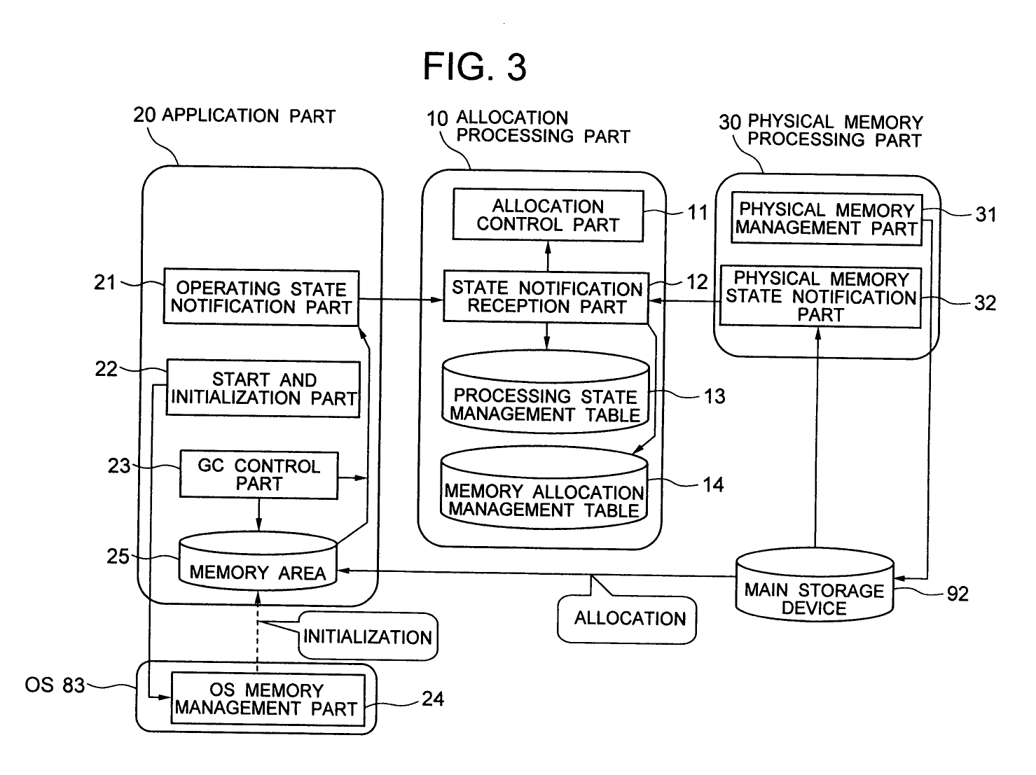

FIG. 3 is a block diagram showing the details of each of the processing parts (allocation processing part 10, application part 20, and physical memory processing part 30), shown in FIG. 1 and FIG. 2.

Allocation processing part 10 is constituted by including an allocation control part 11, a state notification reception part 12, a processing state management table 13, and a memory allocation management table 14.

By giving a resource allocation instruction to Java VM 84 in response to the resource use states which are respectively stored in processing state management table 13 and memory allocation management table 14, allocation control part 11 makes resource use more efficient.

State notification reception part 12 receives notifications on the state of use (level of use, rate of use, and the like) of the resources (physical memory of CPU 91, main storage device 92, et cetera) associated with Java VM 84.

In processing state management table 13, there is stored information (whether or not GC (Garbage Collection) is being processed, and the like) pertaining to processing from among the pieces of information received by state notification reception part 12 from an operating state notification part 21.

In memory allocation management table 14, there is stored information (state of use of the physical memory of main storage device 92) received by state notification reception part 12 from operating state notification part 21 and a physical memory state notification part 32.

Application part 20 has an operating state notification part 21, a start and initialization part 22, a GC control part 23, and a memory area 25.

Operating state notification part 21 notifies, in response to a request from state notification reception part 12, or, even if there is no request, actively, state notification reception part 12 of the state (the state of use of the physical memory of memory area 25 and information on whether GC processing due to GC control part 23 is under execution or not) of the Java VM 84 with which it is itself affiliated.

Start and initialization part 22 executes, when Java VM 84 is started, the initialization processing of the same Java VM 84 (including the allocation of memory area 25) with respect to OS memory management part 24.

GC control part 23 controls the start of GC processing to release unused objects inside memory areas 25. GC processing releases unused memory areas, e.g. by means of a “mark and sweep” method garbage collection algorithm. Of course, it is not limited to a “mark and sweep” method, it being acceptable during execution of the program to apply any specifiable garbage collection method as GC processing for unused areas. A GC processing start opportunity arises when e.g. the CPU rate of use is at or below a threshold and when the memory use location exceeds a preset decision location.

OS memory management part 24 is present inside OS 83 and allocates physical memory of main storage device 92 allocated by hypervisor part 81 to processes of Java VM 84 or the like that operate on OS 83. However, as for OS memory management part 24, in the initialization processing of start and initialization part 22, management processing (allocation processing and release processing, swap-outs and the like, to hard disk devices et cetera) of physical memory to Java VM 84 is halted by an instruction from start and initialization part 22. Instead, the management processing of physical memory to Java VM 84 is executed in accordance with control from allocation control part 11 of allocation processing part 10 and control from Java VM 84.

Memory area 25 is an area of memory used by the programs of program execution part 85, physical memory being allocated from main storage device 92.

Physical memory processing part 30 comprises a physical memory management part 31 and a physical memory state notification part 32.

Physical memory management part 31 partitions the physical memory of main storage device 92 into areas (memory pages) of a prescribed size. And then, physical memory management part 31, together with providing a memory page in response to a memory allocation request from Java VM 84, releases a memory page designated in response to a memory release request from Java VM 84 and returns it to an unallocated state.

In response to a request from state notification reception part 12, or, even if there is no request, actively, physical memory state notification part 32 notifies state notification reception part 12 of the state (idle capacity of the physical memory of main storage device 92) of physical machine 9.

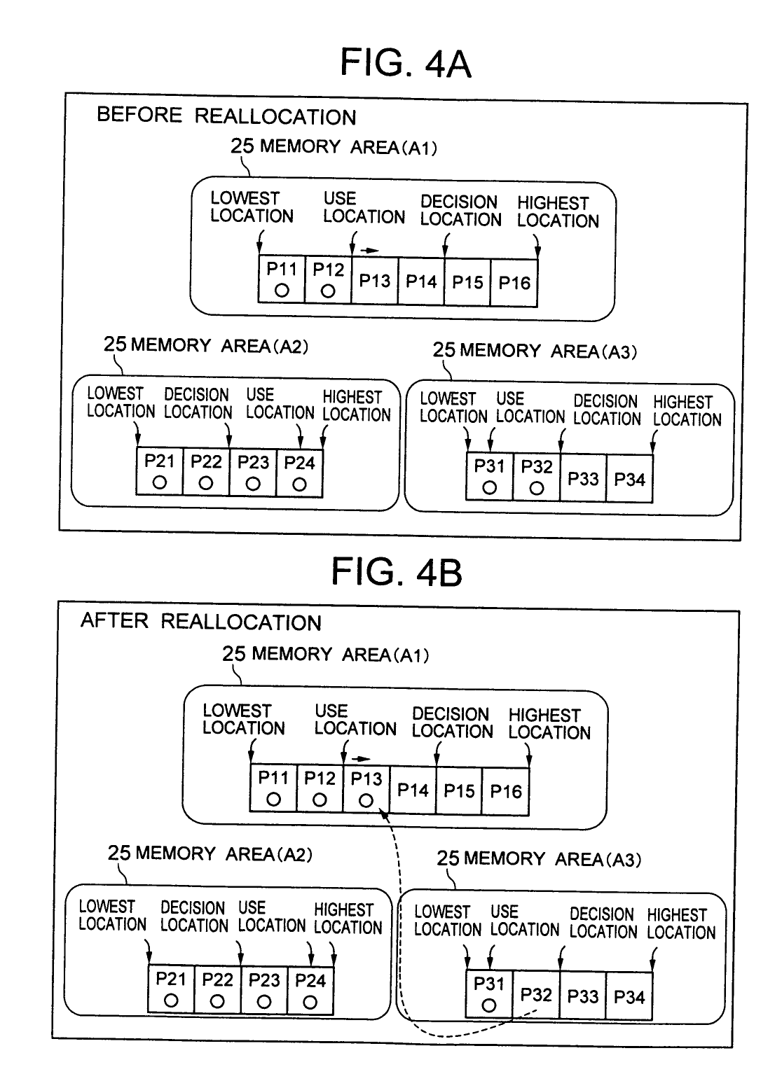

FIGS. 4A and 4B are explanatory diagrams showing physical memory states inside memory areas 25. In each memory area 25, a lowest location (location of the least significant address) indicating a first endpoint of the same area, a highest location (location of the most significant address) indicating a second endpoint of the same area, a use location indicating the most significant location among the used locations inside a memory area 25, and a decision location for starting GC processing by means of the fact that the use location exceeds the decision location are respectively set as pointers indicating locations inside the memory areas.

In other words, a memory area 25 is defined as an area that is continuous from a lowest location to a highest location. And then, the use location of memory area 25 starts from the lowest location (the left end) and, whenever an object is allocated, moves toward the highest location (the right end) by an amount corresponding to the same object only. In other words, the object allocated next is assigned to the memory area, taking the use location to be the starting point.

FIG. 4A illustrates by example three memory areas 25 used respectively by three applications (Application ID=A1, A2, A3).

In memory area 25 with Application ID=A1, physical memory is allocated (marked with “O” in the drawing) with respect to two memory pages (P11, P12) out of six memory pages (P11 to P16).

In memory area 25 with Application ID=A2, physical memory is allocated with respect to all four memory pages (P21 to P24) of the four memory pages (P21 to P24).

In memory area 25 with Application ID=A3, physical memory is allocated with respect to two memory pages (P31, P32) of the four memory pages (P31 to P34).

And then, if the use location of memory area 25 with Application ID=A1 exceeds the top-level page (P12) to which physical memory is allocated, memory is insufficient since physical memory is not allocated (no “O” mark) to pages beyond this (P13 and onwards). Also, in the physical memory managed by physical memory management part 30, it is taken that memory pages with memory in reserve are not present. At this time, since physical memory is allocated newly with respect to memory page P13, it is necessary to reallocate unused physical memory from memory areas 25 with Application IDs other than A1.

FIG. 4B shows a physical memory state, as against the state of FIG. 4A, after reallocation of physical memory has been executed.

First, in memory area 25 with Application ID=A2, since the use location has arrived as far as memory page P24, the four memory pages (P21 to P24) to which physical memory has been allocated are all used. Accordingly, since used physical memory cannot be considered for reallocation, memory area 25 with Application ID=A2 is excluded from consideration for a reallocation.

On the other hand, in memory area 25 with Application ID=A3, since, out of the two memory pages (P31, P32) to which physical memory has been allocated, the use location is limited to P31, only one (P31) of the two memory pages is used. In other words, although the other page, P32, has physical memory allocated, it is an unused memory page.

Accordingly, the physical memory allocated to memory page P32 is temporarily returned and by reallocating the same memory page to memory page P13 inside memory area 25 with Application ID=A1, it is possible to cancel the memory shortage. This reallocation processing is executed in accordance with the control of allocation processing part 10.

In the foregoing, as shown in FIGS. 4A and 4B, allocation processing part 10 can increase memory use efficiency by accommodating an application lacking in physical memory with allocated but unused physical memory.

Here, if the applications with Application ID=A1, A2 are taken to operate on a first virtual machine 82 and the application with Application ID=A3 is taken to operate on a second virtual machine 82, it is possible to implement flexible processing of the memory extended over virtual machine 82. The implementation of this kind of processing of the resources extended over virtual machines 82 is difficult with OS memory management parts 24 of OS 83 that start independently for each virtual machine 82.

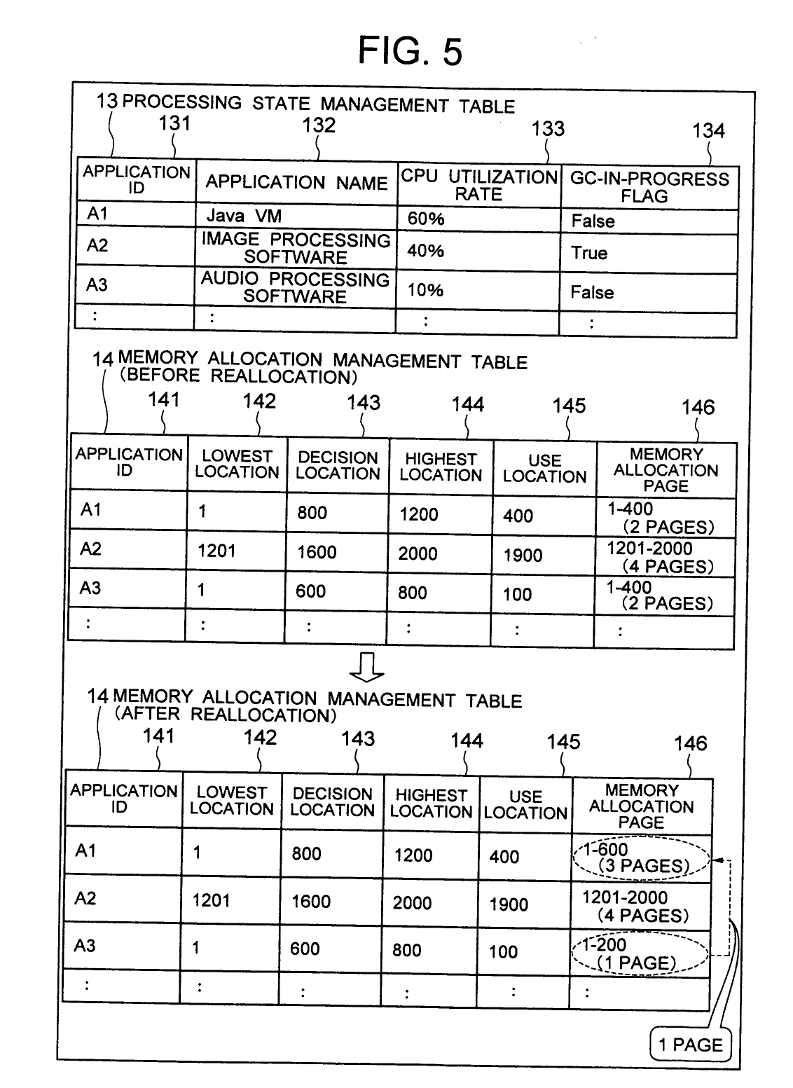

FIG. 5 is a set of tables comprising a processing state management table 13 and two states of memory allocation management tables 14. Further, in FIG. 5, memory allocation management table 14 (before reallocation) corresponds to FIG. 4A and memory allocation management table 14 (after reallocation) corresponds to FIG. 4B.

Processing state management table 13 is constituted by associating an application ID 131 being an ID of a virtual machine 82, an application name 132 being the name of the application indicated by application ID 131, a CPU utilization rate 133 of CPU 91, and a GC-in-progress flag 134 indicating whether GC control part 23 has started (True) or not (False) GC processing.

Memory allocation management table 14 is constituted by associating an application ID 141, a lowest location 142, a decision location 143, a highest location 144, a use location 145, and a memory allocation page 146. The applications of each of the records stored in this memory allocation management table 14 are the subject of state notifications obtained by state notification reception part 12.

Application ID 141 is an application ID of Java VM 84 or the like.

Application name 132 is the name of an application indicated by application ID 141.

Lowest location 142, decision location 143, highest location 144, and use location 145 are pointers indicating, as described in FIGS. 4A and 4B, respective locations within a memory area 25 used by the application.

Memory allocation page 146 is, as described with an “O” mark in FIGS. 4A and 4B, a memory page to which physical memory is allocated within a memory area 25.

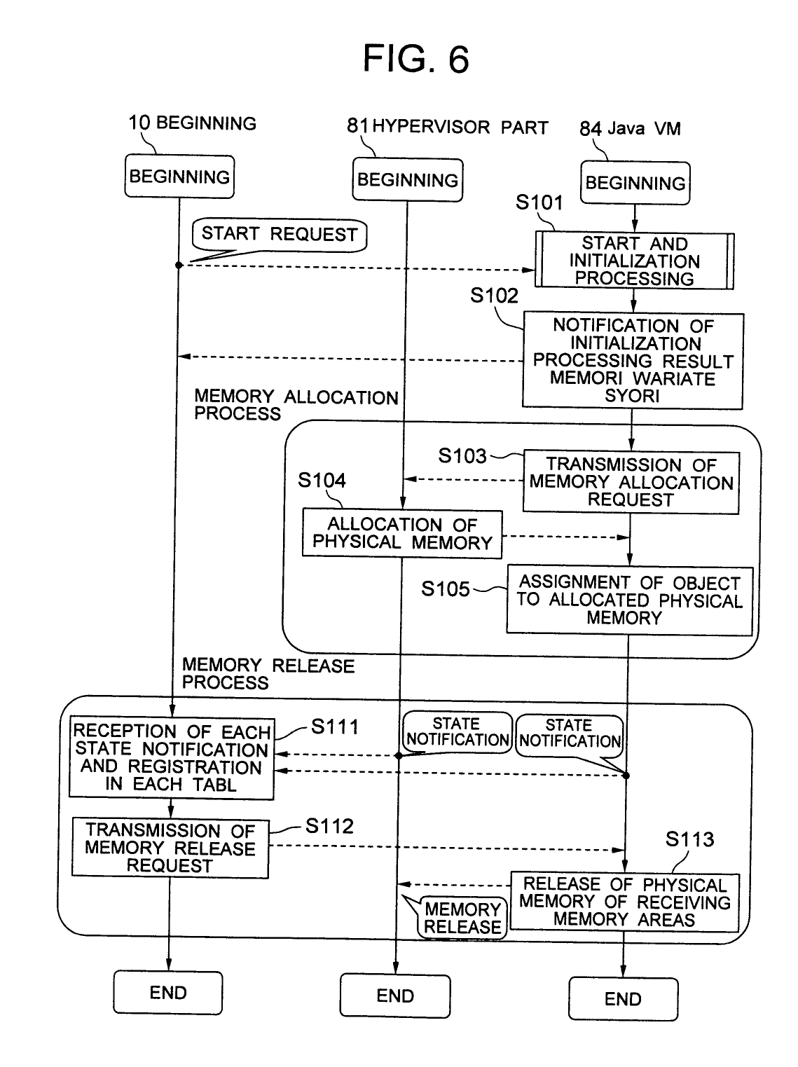

FIG. 6 is a flowchart showing the operation of physical machine 9 of FIG. 1.

As a starting state of this flowchart, it is assumed that a virtual machine environment 8 consisting of one hypervisor part 81 and one or several virtual machines 82 is built into physical machine 9 and that a physical memory management part 30 operates inside the same hypervisor part 81 and an allocation processing part 10 operates on the same virtual machine 82. Further, on each virtual machine 82, an OS 83 (including an OS memory management part 24) is activated.

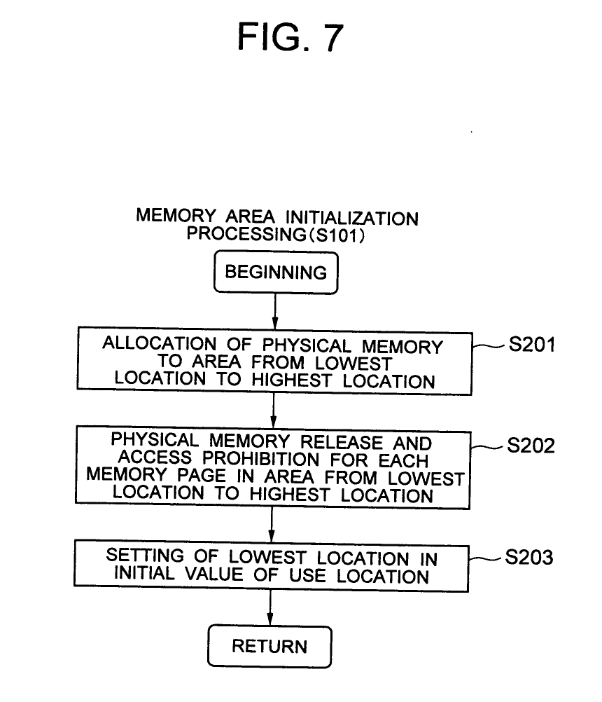

As Step 101, start and initialization part 22 executes (invocation of a subroutine subsequently mentioned in FIG. 7) start and initialization processing for Java VM 84 and application part 20 on virtual machine 82 in accordance with a start request from allocation control part 11. Further, the options specified in the start request are the respective locations (lowest location 142, decision location 143, and highest location 144) of memory area 25 inside the application part 20 to be started.

As Step 102, start and initialization part 22 notifies allocation control part 11 of allocation processing part 10 of the result of initialization processing. Allocation control part 11 registers the notified result in memory allocation management table 14.

Step S103 to Step S105 are a memory allocation process.

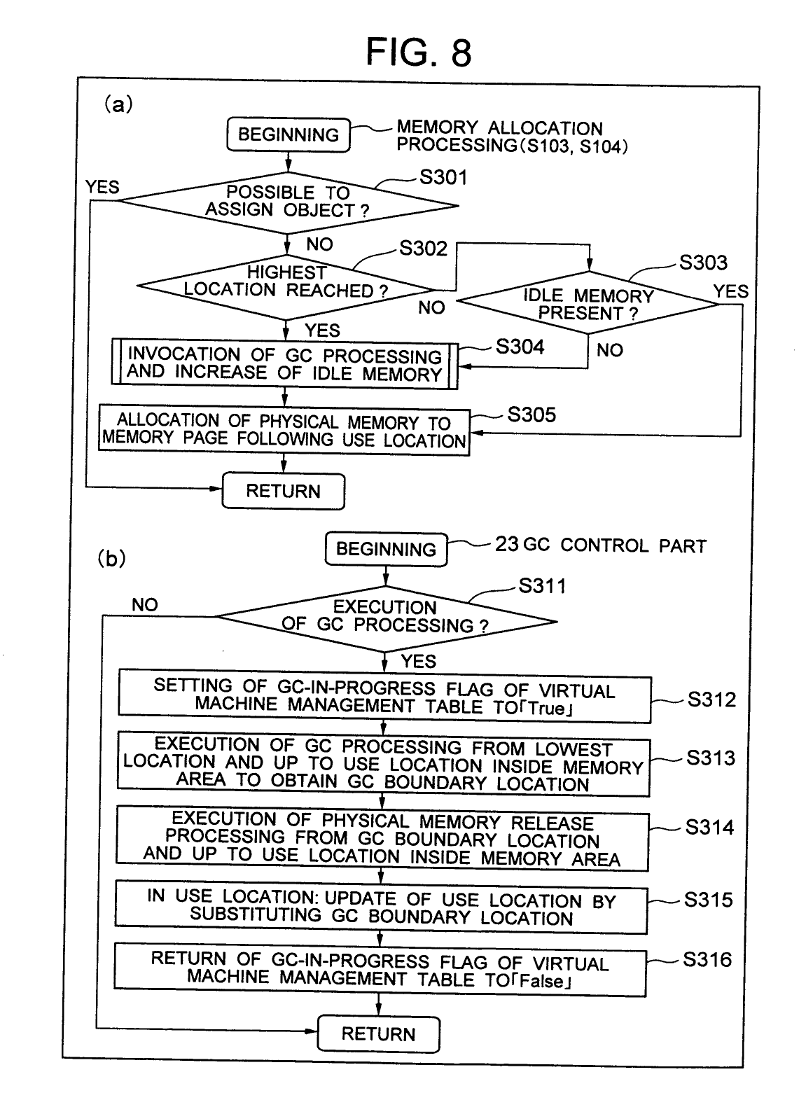

As Step S103, Java VM 84, in response to object assignment processing of the program executed by program execution part 85, generates a memory allocation request to memory area 25, if a memory page to which physical memory is not allocated becomes necessary, and transmits the same memory allocation request to physical memory processing part 30 (invocation of a subroutine subsequently mentioned in FIG. 8A).

As Step S104, physical memory management part 31 receives the request and retrieves and allocates unused physical memory (e.g. memory page P13 in FIG. 4A). In case there is no area that can be allocated, it replies back to application part 20 with a message to the effect that allocation is not possible.

As Step S105, when physical memory allocation processing has succeeded, Java VM 84, in accordance with the reply of Step S104 and together with assigning the object under consideration for assignment in Step S103 to use location 145, updates use location 145 with the next location of the assigned area.

Step S111 to Step S113 are a memory release process.

As Step S111, state notification reception part 12 of allocation processing part 10, at prescribed intervals, registers the notification contents (state notification) from operating state notification part 21 in processing state management table 13 and memory allocation management table 14 and registers the notification contents (state notification) from physical memory state notification part 32 in memory allocation management table 14.

As Step S112, allocation control part 11 transmits, on the basis of the registered contents of processing state management table 13 and memory allocation management table 14, a memory release request to the application part 20 of each application registered in memory allocation management table 14.

In this way, by transmitting a memory release request actively from the side of allocation processing part 10, it is possible to avoid in advance a performance reduction accompanying an application memory shortage, since memory can be preventively interchanged between applications before the memory of an application becomes insufficient.

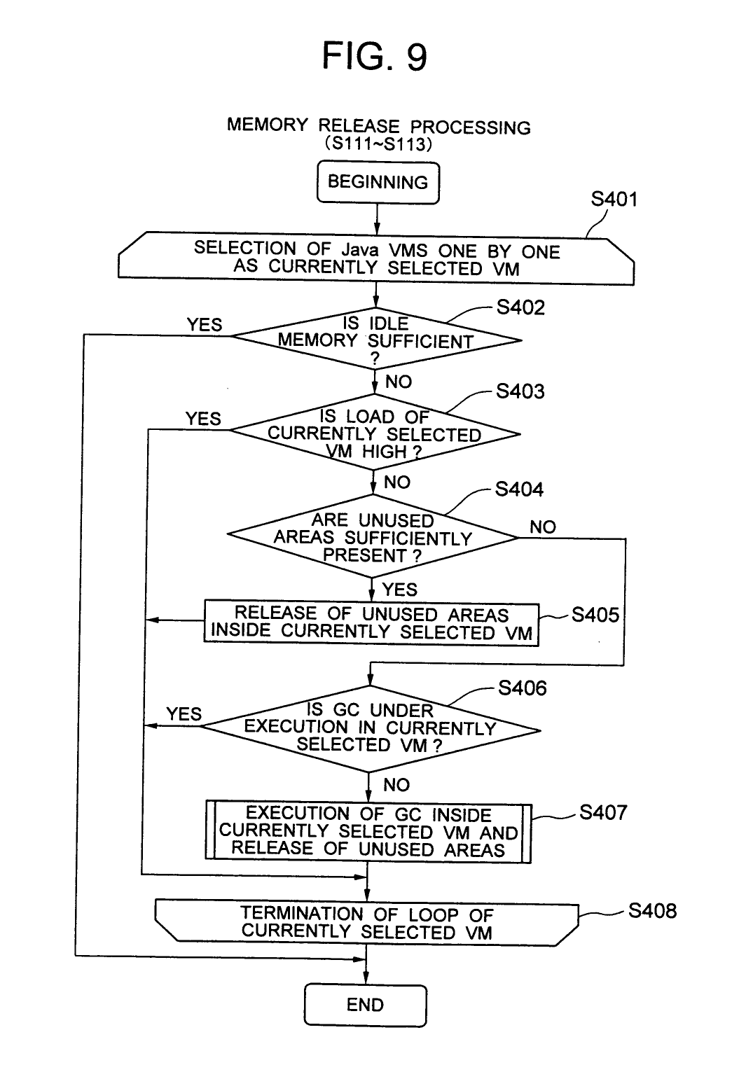

As Step S113, each application part 20 receives a memory release request and by releasing physical memory allocated to receiving memory areas 25, the capacity of physical memory that can be utilized is increased (invocation of a subroutine subsequently mentioned in FIG. 9).

The memory allocation process (Steps S103 to S105) and the process to release allocated memory (Steps S111 to S113), explained in the foregoing, may be mutually processed in parallel. By a repetition of these two processes and by means of the fact that physical memory, which is a limited machine resource, is apportioned to necessary applications at necessary times, the physical memory resources are distributed over a plurality of virtual machines 82 and circulate, so it becomes possible to continue to improve the memory utilization efficiency. Further, by means of the fact that the process of releasing memory that has been allocated is carried out whenever required, before application memory becomes insufficient, it is possible to suppress the generation of application memory shortages and application performance degradation can be prevented.

FIG. 7 is a flowchart showing memory area 25 initialization processing (Step S101) executed by start and initialization part 22.

As Step S201, regarding the areas from lowest location 142 and up to highest location 144, allocation of physical memory is requested to OS memory management part 24. OS memory management part 24 receives the request and, regarding the area from lowest location 142 and up to highest location 144, allocates physical memory.

As Step S202, regarding each memory page of the area from lowest location 142 and up to highest location 144, there is requested, with respect to OS memory management part 24, access right setting processing to the effect of prohibiting access, from the OS 83 corresponding to each memory page of physical memory allocated to the same memory pages in Step S201 or from each process on the same OS 83, or the release of allocated physical memory is requested with respect to physical memory management part 31. OS memory management part 24 receives the request with respect to the prescribed memory pages and sets the access rights with respect to physical memory to “prohibited” by invoking an OS 83 system call.

By means of the process of this Step S202, each memory page of memory area 25 enters a state where an area is allocated but physical memory is not allocated, so it falls outside consideration by the management of OS memory management part 24.

As Step S203, lowest location 142 is set as the initial value of use location 145.

FIGS. 8A and 8B are flowcharts showing the details of processing by application part 20 of access to a memory area 25.

FIG. 8A is a flowchart showing memory area 25 object assignment processing executed by application part 20. As for this flowchart, an object under consideration for assignment are set and executed.

As Step S301, it is judged whether the object under consideration for assignment can be assigned to use location 145 of memory area 25. Specifically, it is judged, when unused physical memory is allocated, that assignment is possible from use location 145 to the area portion corresponding to the object under consideration for assignment. E.g., if use location 145 in FIG. 4A has reached memory page P13, it is judged that assignment is not possible, since unused physical memory is not allocated (no “O” mark). If there is a “Yes” in Step S301, the flow returns from the present flowchart to the point of invocation and if there is a “No”, the flow proceeds to Step S302.

As Step S302, it is judged whether use location 145 has reached highest location 144 or not. If there is a “Yes” in Step S302, the flow proceeds to Step S304, and if there is a “No”, the flow proceeds to Step S303.

As Step S303, there is an enquiry to physical memory management part 31 whether idle physical memory is present or not and, as a result thereof, it is judged whether to increase physical memory or not by means of GC processing. If there is a “Yes” in Step S303, the flow proceeds to Step S305 and if there is a “No”, the flow proceeds to S304.

As Step S304, GC processing (FIG. 8B) of memory area 25, executed by GC control part 23, is invoked.

As Step S305, a request to the effect of allocating physical memory to the memory page following use location 145 (e.g. memory page P13 of FIG. 4A) is transmitted to physical memory management part 31.

FIG. 8B is a flowchart showing GC processing with respect to a memory area 25, executed by GC control part 23. This flowchart is executed specifying application ID 141 of the Java VM 84 activated by GC control part 23.

As Step S311, it is judged whether to execute GC processing or not. E.g., when use location 145 corresponding to the specified application ID 141 does not exceed decision location 143 (e.g. memory page P12 of FIG. 4A), one cannot particularly expect to ensure a new memory area by means of GC processing, since memory area 25 is not yet used much, so it is judged that GC processing is not executed. If there is a “Yes” in Step S311, the flow proceeds to Step S312 and if there is a “No”, the flow returns to the point of invocation of the present flowchart.

In Step S312, regarding the record including an application ID 131 of processing state management table 13 that matches the specified application ID 141, GC-in-progress flag 134 of the same record is set to “True”.

In Step S313, GC processing is executed, taking under consideration the areas from lowest location 142 and up to use location 145 inside memory area 25, and a GC boundary location is obtained. By means of this GC processing, when unused areas (assigned areas of unnecessary objects and the like) from among the areas from lowest location 142 and up to use location 145 are thinly sliced, it is possible to ensure a continuous unused area by moving used areas (assigned areas of necessary objects and the like) to fill the same from lowest location 142.

Due to GC processing, the areas from lowest location 142 and up to use location 145 can be divided up into a used area and an unused area. And then, the boundary location between these two areas is taken to be the GC boundary location.

In Step S314, a process to release physical memory allocated to areas from the GC boundary location within memory area 25 and up to use location 145 is executed. As a result, if GC control part 23 transmits a physical memory release request to physical memory management part 31, physical memory management part 31 releases the physical memory allocated to the memory pages specified in the same request.

Further, in the process of Step S314, instead of releasing all the physical memory of the areas from the GC boundary location and up to use location 145, it is acceptable to leave a specified quantity of physical memory ensured without release and release the remaining physical memory. In this way, the quantity of memory that can be shared between Java VMs 84 can be restricted.

Moreover, it is acceptable to omit the S314 process. In this way, a state is entered in which memory pages with allocated physical memory are left intact inside a Java VM 84.

In this way, by leaving unused memory pages inside a Java VM 84, it is possible, since the number of allocations due to memory shortage can be reduced, to suppress a certain overhead in the memory allocation processing. Since these unused memory pages are appropriately released with the S405 process subsequently mentioned in FIG. 9, it will not become a main factor in reducing memory utilization efficiency.

In Step S315, by substituting the GC boundary location for the use location 145 corresponding to the specified application ID 141, use location 145 is updated.

In Step S316, regarding the record in which GC-in-progress flag 134 was set to “True” in Step S312, GC-in-progress flag 134 is returned to “False”.

FIG. 9 is a flowchart showing the details of an active memory release request process executed by allocation control part 11.

In Step S401, a loop is started in which the Java VMs 84 registered in memory allocation management table 14 are selected one by one as the currently selected VM.

In Step S402, it is judged whether the unallocated physical memory managed by physical memory management part 31 is sufficiently present or not. If there is a “Yes” in Step S402, the process comes to an end and if there is a “No”, the flow proceeds to S403.

In Step S403, it is judged whether the load of the currently selected VM is high or not. Specifically, when CPU utilization rate 133 corresponding to the currently selected VM of processing state management table 13 is equal to or greater than a prescribed threshold (e.g. 70%), it is judged that the load is high. The system is devised not to obstruct the processing of the currently selected VM by not carrying out execution of release processing of memory with low priority when the load of the currently selected VM is high. If there is a “Yes” in Step S403, the flow proceeds to Step S408 and if there is a “No”, the flow proceeds to Step S404.

Further, regarding the load evaluation value of the currently selected VM, the number of requests being processed et cetera or any indicator, may be used instead of CPU utilization rate 133 to evaluate the load, in the case where the application operating on Java VM 84 is an application server.

In Step S404, it is judged whether or not sufficient unused area is present in memory area 25 inside the currently selected VM. Here, the expression “unused area” refers to an area to which physical memory has been allocated, inside the area from the location following use location 145 and up to highest location 144 (e.g. memory page P32 in FIG. 4A). If there is a “Yes” in Step S404, the flow proceeds to Step S405 and if there is a “No”, the flow proceeds to Step S406.

In Step S405, the unused area inside the currently selected VM is returned. And then, the flow proceeds to Step S408.

In Step S406, it is judged whether or not GC is already under execution in the currently selected VM. Specifically, when the GC-in-progress flag 134 corresponding to the selected VM of processing state management table 13 is “True”, it is judged that GC is being executed. And then, when GC is being executed, it is judged not to execute GC processing, so as not to duplicate and execute GC processing. If there is a “Yes” in Step S406, the flow proceeds to Step S408 and if there is a “No”, the flow proceeds to Step S407.

In Step S407, by invoking the subroutine of FIG. 8B, GC is executed inside the currently selected VM and unused area is released.

In Step S408, the loop from Step S401 of the currently selected VM is terminated.

According to the present embodiment explained in the foregoing, allocation processing part 10, by actively controlling the unused area (or the area that it has been possible to allocate by starting GC processing) to return it to physical memory management part 31, is able to increase the capacity of physical memory that can be allocated by physical memory management part 31, in spite of the fact that physical memory of main storage device 92 is allocated from among memory areas 25. And then, as for physical memory management part 31, efficient use of memory becomes possible by reallocating the idle memory to another Java VM 84. In other words, by lending idle memory included in a certain partitioned memory area to a system managing a separate memory area, memory can be efficiently put to practical use.

Further, by taking the opportunity of starting GC processing (Step S403) at a time when the load of the Java VM 84 thereof is low, the influence of the halt time due to GC can be restrained to be small. In other words, it becomes possible to control the release of idle memory in response to the load state of a program.

It should be further understood by those skilled in the art that although the foregoing description has been made on embodiments of the invention, the invention is not limited thereto and various changes and modifications may be made without departing from the spirit of the invention and the scope of the appended claims.

1. A memory management method which, together with building, on a physical machine, a virtual machine environment constituted by having one or several virtual machines and a hypervisor part for operating the same virtual machine(s), allocates physical memory inside a main storage device of said physical machine to a memory area used by an application part operating on said virtual machine; and
in which:
said virtual machine operates an allocation processing part and said application part;
said application part, by prohibiting physical memory allocation processing and release processing from said virtual machine regarding said used memory area and transmitting a request to the effect of allocating physical memory to a physical memory processing part inside said hypervisor part, makes said physical memory processing part allocate unallocated physical memory with respect to said memory area; and
said allocation processing part, when said unallocated physical memory is scarce, transmits, to each of said application parts operating respectively on said one or several virtual machines, an instruction for the release, from said memory areas, utilized by each of said application parts, of memory pages which are unused but for which physical memory is allocated.

2. The memory management method according to claim 1, wherein said allocation processing part receives, from each said application part, a notification of the load value of said application part and stores the result thereof in a storage means; and
excludes those of said application parts for which the load value stored in said storage means is equal to or greater than a prescribed value from said application parts transmitting release instructions for said memory pages.

3. The memory management method according to claim 2, wherein said allocation processing part stores, in said storage means, the CPU utilization rate of each said application part as the load value of each said application part.

4. The memory management method according to claim 2, wherein said allocation processing part stores, in said storage means, the number of requests being processed in each said application part as the load value of each said application part.

5. The memory management method according to claim 1, wherein said application part, if it receives said memory page release instruction, instructs said physical memory processing part to release physical memory that is allocated to memory pages for which objects within utilized ones of said memory areas are not assigned.

6. The memory management method according to claim 1, wherein said application part, if it receives said memory page release instruction, instructs said physical memory processing part, by targeting memory pages for which objects within utilized ones of said memory areas have been assigned and executing garbage collection processing to ensure memory pages for which objects are not assigned and release physical memory that is allocated to the same memory pages.

7. A memory management program for making said physical machine execute the memory management method according to claim 6.

8. A memory management device which, together with building, on a memory management device being a physical machine, a virtual machine environment constituted by having one or several virtual machines and a hypervisor part for operating the same virtual machine(s), allocates physical memory inside a main storage device of said physical machine to a memory area used by an application part operating on said virtual machine; and
in which:
said virtual machine operates an allocation processing part and said application part;
said application part, by prohibiting physical memory allocation processing and release processing from said virtual machine regarding said used memory area and transmitting a request to the effect of allocating physical memory to a physical memory processing part inside said hypervisor part, makes said physical memory processing part allocate unallocated physical memory with respect to said memory area; and
said allocation processing part, when said unallocated physical memory is scarce, transmits, to each of said application parts operating respectively on said one or several virtual machines, an instruction for the release, from said memory areas, utilized by each of said application parts, of memory pages which are unused but for which physical memory is allocated.
